(19) United States
(12) Patent Application Publication
(10) Pub. No.: US 2016/0011034 A1
(43) Pub. Date: Jan. 14, 2016

(54) RADAR LEVEL DETECTOR AND METHOD FOR LEVEL MEASUREMENT OF BULK PRODUCTS IN TANKS

(71) Applicants: VLADIMIR VINIAMINOVICH LIBERMAN, TULA (RU); ALEXANDR VLADIMIROVICH LIBERMAN, TULA (RU); GENNADY GENNADYEVICH LICHKOV, TULA (RU); SERGEI ALEKSANDROVICH NOVIKOV, TULA (RU)

(72) Inventors: VLADIMIR VINIAMINOVICH LIBERMAN, TULA (RU); ALEXANDR VLADIMIROVICH LIBERMAN, TULA (RU); GENNADY GENNADYEVICH LICHKOV, TULA (RU); SERGEI ALEKSANDROVICH NOVIKOV, TULA (RU)

(21) Appl. No.: 14/793,048

(22) Filed: Jul. 7, 2015

(30) Foreign Application Priority Data
Jul. 11, 2014 (RU) 2014128739

(51) Int. Cl. G01F 23/284; H01Q 3/34; H01Q 9/04

(52) U.S. Cl. CPC G01F 23/284; H01Q 9/0407; H01Q 3/34

(57) ABSTRACT

The present invention provides improved performance characteristics due to high reliability in measurements in tanks for a range of bulk products, regardless of the operational process geometric shape, including measurement in explosive environments. Essence of the proposed method amounts to the fact that, apart from transmission in predisposed direction and receipt of reflected from the surface of studied product radar signals, whose frequency varies linearly, measurement of frequency difference between emitted and reflected signals, isolation of valid signal and distance calculation, additionally electronic scanning is performed of the microstrip antenna directional pattern, emit and receive reflected radar signals for various angular positions of the directional pattern, measure reflected signal strength, perform spectral processing of the reflected signals, on the basis of which and entered geometric parameters of the measured tank is calculated optimal angular position of the directional pattern, generate control signal for the microstrip antenna directional pattern.

### CROSS-REFERENCE TO RELATED APPLICATIONS

This application claims priority to Russian Patent Application No. 2014128739, filed Jul. 11, 2014, the entire disclosure of which is expressly incorporated herein by reference.

### FIELD OF THE INVENTION

This invention is related to the field of radar measurement technology and may be applied in development of control and measurement systems for bulk products in the tanks, operated in the construction, mining and petro-chemical industries including explosive environments.

### BACKGROUND OF THE INVENTION

There is known measurement method for bulk products involving application of variations in position of the antenna directional pattern inside the tank in accordance with preset algorithm (U.S. Pat. No. 6,634,234).

Essence of this method using adjustable measuring head part amounts to exposure of measured product to radar signal of appropriate structure and fixed power, subsequent receipt of reflected from measured product signal with the help of transceiver module, located inside studied tank in the one of three possible angular positions, its processing in accordance with preset algorithm and generation of the control signal for adjustment of directional pattern angular position.

Implementation method for adjustment of directional pattern angular position includes transceiver module with antenna, located on the actuator, which, in its turn, is located inside the tank. Actuator and transceiver module are connected to the control module, which, in its turn, is connected to the display module. At that all equipment except for actuator and transceiver module is located outside the inner space of the tank. Control of the angular position of the directional pattern of the transceiver module is performed by transmitting control signals from the control module to actuator. Process of the control signals generation involves application of special algorithms for processing of reflected signals, coming from transceiver module based on the current distance to the surface of measured product.

Main shortcoming of this method and its implementation device for changing position of the directional pattern is there being mechanical unit—actuator. Such mechanical method for changing position of directional pattern by changing orientation of the entire transceiver module has low reliability due to the fact that mechanical components are contaminated by dust which is inevitably present inside bulk product tanks.

Fixed number (equals three) of possible angular positions of the directional pattern significantly limits level detector performance. This is due to the fact that measurement of the bulk products level, unlike liquids, has its own specifics, amounting to the fact that surface of such products is not smooth and in some cases may include irregular structure. Thus there is no specular reflection of probing signal which sometimes leads to its partial or full loss. In this case changing of the directional pattern angular position may contribute to the appearance of valid signal.

With sufficiently narrow antenna directional pattern (about 2-4 degree) may be required a much larger number of possible angular positions of the antenna direction. In addition to the above, it should be noted that installation of the actuator together with transceiver module inside of the measured tank excludes ability to operate in explosive environments. As an example of products which may form an explosive environment may be mentioned charcoal, carbon black, grain, formulated feed.

### SUMMARY OF THE INVENTION

The authors faced the challenge to develop method for measurement of bulk products level and its implementation device, reliably operating in various types of tanks, containers for a wide range of products which may also form an explosive mixture.

This task was achieved by the fact that in the known method for level measurement of the bulk product, we transmit and receive reflected radar signals whose frequency varies linearly, measure frequency difference between transmitted and reflected from the surface of measured product signal, isolate and process radar signal with the help of special algorithms and calculate distance, in addition electronically scan directional pattern of the microstrip antenna, transmit and receive reflected radar signals for various angular positions of the directional pattern, take measurements of the reflected signal strength, perform spectral processing of the reflected radar signals, which, along with entered geometrical parameters, becomes the basis for optimal angular position of the directional pattern, generate control signal for the microstrip antenna directional pattern.

The radar level detector for measurement of the bulk products includes level sensor, connected to the microstrip antenna by the means of waveguide transition, phase-shifting devices, installed on the microstrip antenna, and electrically interconnected detecting section and control block, together forming a control channel for the microstrip antenna directional pattern.

Detecting section is located on the emitting surface of the microstrip antenna.

The control unit is connected to the intrinsically safe power supply.

The control unit consists of a microcontroller, control command decoder, control signal generator for the phase shifters, at this decoder output is connected to the input of the microcontroller, the output of which is connected to the input of the control signal generator for phase shifters, output of which is connected to phase shifters, and control command decoder input is connected to the detecting section.

Introduction of the control channel for the microstrip antenna directional pattern allows for simple, without application of a mechanical method, change in the position of the microstrip antenna directional pattern inside measured tank in accordance with preset algorithm, which leads to achievement of technical outcome in a way of improved performance characteristics due to keeping the possibility to measure distance to the bulk product surface regardless of its form, including measurements in explosive environment.

The inventive method for level measurement of bulk products and radar level detector for its implementation have a range of essential features, not known in the technical background for similar purpose devices which allows to conclude that invention complies with “novelty” criteria.

The inventive method for measurement of bulk products and radar level detector for its implementation, according to the applicant and the authors' opinion, complies with “inventive step” criteria because they are not direct result of specialists' technical background, i.e. not known from available sources of scientific, technical and patent information at the application date.

The invention is related to the field of radar measurement technology and may be applied in development of control and level measurement systems for bulk products in the tanks, operated in the construction, mining and petrochemical industries, including an explosive environment.

In accordance with one embodiment of the present invention, the technical result amounts to improved performance characteristics due to the high reliability in measurements in various types of tanks for a wide range of bulk products regardless of created in the operational process geometric shape, including measurement in explosive environments.

Essence of the proposed method amounts to the fact that, apart from transmission in predisposed direction and receipt of reflected from the surface of studied product radar signals, whose frequency varies linearly, measurement of frequency difference between emitted and reflected signals, isolation of valid signal and distance calculation, additionally we perform electronic scanning of the microstrip antenna directional pattern, emit and receive reflected radar signals for various angular positions of the directional pattern, measure reflected signal strength, perform spectral processing of the reflected signals, on the basis of which and entered geometric parameters of the measured tank is calculated optimal angular position of the directional pattern, generate control signal for the microstrip antenna directional pattern.

Radar level detector consists of the level sensor, intrinsically safe power supply, control unit, waveguide transition and microstrip antenna.

In addition to the level sensor connected to the microstrip antenna, where phase shifters are installed, the radar level detector, for implementation of the described above method, includes waveguide transition and electrically interconnected detecting section and control unit.

In additional claims we concretize design of the level detector blocks and units and connections between them.

In accordance with one illustrative embodiment of the present invention, a method of measurement for bulk products which includes transmission in the predetermined direction and receipt of radar signals is provided, frequency of which varies linearly, measurement of frequency difference between transmitted and reflected from the studied product surface signal, isolation of the valid signal and distance calculation; this method is set apart by electronic scanning of the microstrip antenna directional pattern, transmission and receipt of reflected radar signals for various angular positions of the directional pattern, measurement of the reflected signal strength, spectral processing of reflected signals on the basis of which and entered geometric parameters of the measured tank is calculated optimal angular position of the directional pattern, generation of the control signal for the microstrip antenna directional pattern.

In accordance with another illustrative embodiment of the present invention, a radar level detector for implementation of the above-described method is provided, including a level sensor, connected to the microstrip antenna through waveguide transition, phase shifters, installed on the microstrip antenna; this device is set apart by the fact that the radar level detector includes additional, electrically interconnected, detecting section and control block, together forming a control channel for the microstrip antenna directional pattern.

In accordance with an aspect of the above embodiment, the detecting section is located on the microstrip antenna emitting surface.

In accordance with another aspect of the above embodiment, the control block is connected to the intrinsically safe power supply.

In accordance with yet another aspect of the above embodiment, the control block is designed as microcontroller, control command decoder, control signal generator for the phase shifters, at this decoder output is connected to the microcontroller input, output of which is connected to the input of the control signal generator for phase shifters, output of which is connected to the phase shifters, and the input of the control command decoder is connected to the detecting section.

### BRIEF DESCRIPTION OF THE DRAWINGS

Essence of the proposed method of measurement for bulk products in tanks and radar level detector for its implementation will be explained with the help of drawings, where:

FIG. 1 presents block diagram of the radar level detector;

FIG. 2 presents schematic diagram of the control unit;

FIG. 3 presents structure of the signal formed by the level sensor

FIG. 4 presents view of inner surface of the microstrip antenna; and

FIG. 5 presents view of outer emitting surface of the microstrip antenna.

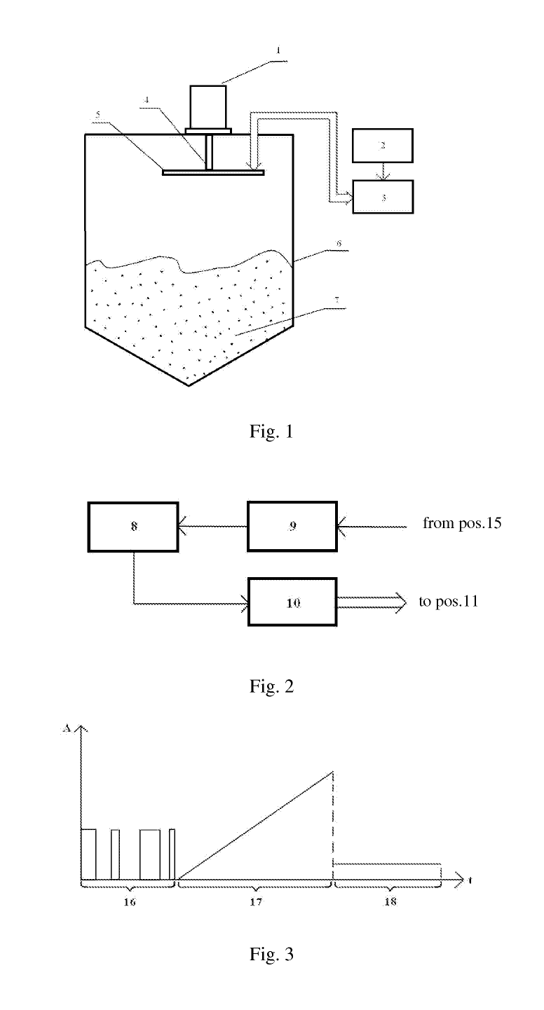

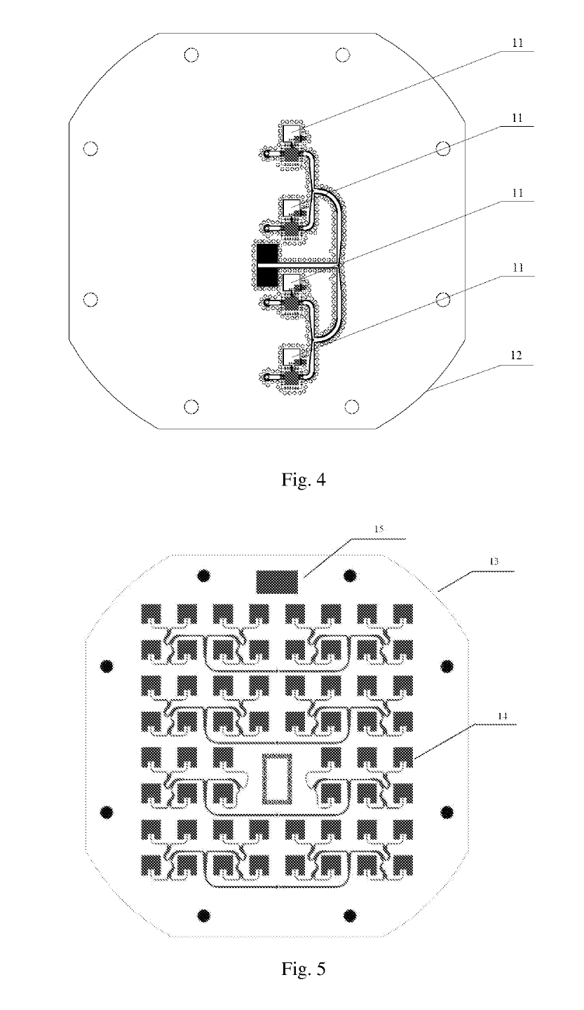

### DETAILED DESCRIPTION OF THE INVENTION

Radar level detector consists of the level sensor 1, intrinsically safe power supply 2, control unit 3, waveguide transition 4 and microstrip antenna 5. Bulk product 7 is in the tank 6.

Control block 3 includes microcontroller 8, control command decoder 9 and control signal generator 10 for the phase shifters 11.

The microstrip antenna 5 has inner side 12 there are located four phase shifters 11 and outer emitting side 13, where there are located emitting elements 14 and detecting section 15. As controlled phase shifters 11 are used microchips HMC 933LP4E manufactured by Hittite Microwave Corporation. Microchip includes varicaps and matching circuits.

Radar level detector operates as follows.

Level sensor 1 generates and emits a radar signal which through waveguide transition 4 comes to the microstrip antenna 5. Emitted by the microship antenna 5 signal in the direction of bulk product 7, distance to which to be measured, is reflected from the product surface and returned to the level sensor 1. Frequency of the emitted signal changes over time in a linear fashion. As a result of interaction between emitted and reflected signals, in the level sensor 1 is formed whole range of spectral components, which frequency carries information about distance to the product surface. After application of special data processing algorithms, output of the level sensor 1 has current distance value in digital form.

The control algorithm for the microstrip antenna 5 directional pattern involves finding the optimal angle for directional pattern by criterion of maximal level of the reflected from product 7 surface signal. Determination of the scan boundaries is performed with account to the width of the microstrip antenna 5 directional pattern, geometric parameters of the tank 6, current distance and angle characteristics. Changing of the microstrip antenna 5 directional pattern angular position is performed by controlling phases of the radar signal, excited by various groups of emitting elements 14.

Controlling of the phase shifters 11 is performed via the control unit 3. Generation of the control signal is based on commands, transmitted from the output of detecting station 15 to the input of control commands decoder 9. Input of the control commands decoder 9 receives pulse sequence 16, which amounts to a pulse-width modulation signal.

This signal is a set of commands, formed in the level sensor 1 and emitted by the microstrip antenna 5, similar to a radar signal on one of the frequencies within operational range of the level sensor 1. Detecting section 15 works as a commands receiver. Control pulses 16 and radar signal transmission are separated in time. Temporal structure of the signal is presented on the FIG. 3. Here, along with control pulses 16, radar signal is generated in the area 17 and received signals are processed in the area 18.

On the basis of transmitted from the output of control command decoder 9 data, the microcontroller 8, with the help of special algorithm, controls operation of the control signal generator 10 for phase shifters 11, output of which is connected to the phase shifters 11.

Control unit 3 is powered from the intrinsically safe power supply 2. Circuitry of the control unit 3 and microstrip antenna 5 allows to manufacture and certify these units in intrinsically safe version which leads to the possibility of certification of the radar lever detector for operation in explosive environment, using previously certified level sensor 1.

Company-applicant has developed design documentation for the inventive radar level detector and manufactured prototype, testing of which confirmed serviceability and advantages as compared to known designs. It allows to conclude that “industrial applicability” criteria is applicable to the invention.

What is claimed is:

1. A method of measurement for bulk products which includes transmission in the predetermined direction and receipt of radar signals, frequency of which varies linearly, measurement of frequency difference between transmitted and reflected from the studied product surface signal, isolation of the valid signal and distance calculation; this method is set apart by electronic scanning of the microstrip antenna directional pattern, transmission and receipt of reflected radar signals for various angular positions of the directional pattern, measurement of the reflected signal strength, spectral processing of reflected signals on the basis of which and entered geometric parameters of the measured tank is calculated optimal angular position of the directional pattern, generation of the control signal for the microstrip antenna directional pattern.

2. A radar level detector for implementation of the method in accordance with claim 1, including a level sensor, connected to the microstrip antenna through waveguide transition, phase shifters, installed on the microstrip antenna; this device is set apart by the fact that the radar level detector includes additional, electrically interconnected, detecting section and control block, together forming a control channel for the microstrip antenna directional pattern.

3. The radar level detector according to claim 2, wherein the detecting section is located on the microstrip antenna emitting surface.

4. The radar level detector according to claim 2, wherein the control block is connected to the intrinsically safe power supply.

5. The radar level detector according to claim 4, wherein the control block is designed as microcontroller, control command decoder, control signal generator for the phase shifters, at this decoder output is connected to the microcontroller input, output of which is connected to the input of the control signal generator for phase shifters, output of which is connected to the phase shifters, and the input of the control command decoder is connected to the detecting section.
